(19) United States
(12) Patent Application Publication
(10) Pub. No.: US 2010/0223212 A1
(43) Pub. Date: Sep. 2, 2010

(54) TASK-RELATED ELECTRONIC COACHING

(75) Inventors: Dragos A. Manolescu, Kirkland, WA (US); Matthew Jason Pope, Seattle, WA (US); Raymond E. Ozzie, Seattle, WA (US); Eric I-Chao Chang, Bejing (CN); Henricus Johannes Maria Meijer, Mercer Island, WA (US); F. David Jones, Bellevue, WA (US); Mary P. Czerwinski, Woodinville, WA (US); Alex David Daley, Kenmore, WA (US)

Correspondence Address: LEE & HAYES, PLLC, 601 W. RIVERSIDE AVENUE, SUITE 1400, SPOKANE, WA, 99201, US

(73) Assignee: MICROSOFT CORPORATION, Redmond, WA (US)

(21) Appl. No.: 12/394,212

(22) Filed: Feb. 27, 2009

(51) Int. Cl. G06F 15/18; G06F 3/01; G06N 5/02

(52) U.S. Cl. 706/12; 715/707; 706/46

(57) ABSTRACT

Providing for task-related electronic feedback based on user interaction with a communication network is described herein. By way of example, user interactions the network or a network interface can be monitored to identify user activities performed in conjunction with a task. A rating for performance of the task can be obtained via comparison of user activities with benchmark performance activities. Based on the rating and user-benchmark comparison, inefficiencies can be identified, along with corrective actions for such activities. The corrective actions can then be output to coach the user on techniques for improving performance of the task. Accordingly, by employing corrective feedback based on monitored user activity, personal training can be automated, potentially reducing time and cost of such training.

### BACKGROUND

Development of computers and computer tools has lead to remarkable advancements in science, technology, computational analysis and communication. Many tasks can be automated due to such advancements, rather than implemented manually by individuals. Common examples of task automation include data analysis, automated robotics, telecommunications exchanges, and physical part fabrication, to name but a few. Taken individually, computer-related task automation has provided significant advancements in human activity and production. In sum, however, such automation of tasks has dramatically changed the standard of human living in a relatively short span of years.

In addition to task automation, computers and computer networking have also provided significant changes to human social and business interaction. On the enterprise side, efficiencies with which individuals can share information, perform tasks, disseminate instructions, search for knowledge-based resources, expose data to users, or share user concerns have greatly increased by advantages provided by inter-personal networks. In regard to social networks, user inter-connectivity and inter-relatedness have been increased as social networking websites have enabled users to share personal information, media files, media applications, pictures, videos, audio, and so on, over the Internet.

As communication networks and computer devices become more prevalent and drop in price, greater numbers of users can afford to join in the electronic communication revolution. In recent years, a substantial portion of the global population has been able to afford at least one electronic networking device, and many are able to afford multiple such devices. Accordingly, the electronic communication revolution has truly become a global phenomenon, enabling near real-time personal and business interaction throughout the globe in a manner heretofore unknown.

### SUMMARY

The following presents a simplified summary in order to provide a basic understanding of some aspects of the claimed subject matter. This summary is not an extensive overview. It is not intended to identify key/critical elements or to delineate the scope of the claimed subject matter. Its sole purpose is to present some concepts in a simplified form as a prelude to the more detailed description that is presented later.

The subject disclosure provides for task-related electronic feedback based on user activities pertinent to performance of a task. The activities can be identified and characterized based on a user's interactions with an electronic device or a network coupled to the device. Once characterized, the user activities can be rated as a function of effectiveness in performing the task. The rating can be based, for instance, on a comparison of the interactions, activities or performance with a performance benchmark. As one example, time required in completing the task as well as effectiveness and efficiency of task performance can be determined and compared with the benchmark.

In some aspects of the subject disclosure, a performance rating for a task can be utilized to provide user feedback or coaching. The feedback/coaching can be directed toward increasing the performance rating, or improving task efficiency or performance results. Thus, depending on a benchmark employed in generating the performance rating, a user can be coached on techniques and methods of expert users, trained on organizational standards, or given comparative results to gauge personal performance, while the user is engaged in accomplishing tasks. Accordingly, task-related training and personal analysis can be conducted automatically and in parallel with task performance.

According to additional aspects, the subject disclosure can provide predictive user guidance based on organizational or individual goals pertaining to or affected by a monitored task. A set of rules can be defined based on preserving the goal, and specific actions can be suggested to a user if a user activity potentially impacts the goal. For instance, where a user task affects other individuals working on similar tasks or employing a common set of resources, the specific actions can be tailored to avoid resource collision, improving overall efficiency of the resources in aiding or advancing the various tasks.

According to still other aspects of the subject disclosure, benchmark performance models can be implemented as exportable/importable files or applications. Such files/applications can be exchanged between organizations or individuals for cross-training purposes. Thus, for instance, a benchmark performance model trained by one organization having successful results in a particular task can be shared with other organizations, to leverage that success.

The following description and the annexed drawings set forth in detail certain illustrative aspects of the claimed subject matter. These aspects are indicative, however, of but a few of the various ways in which the principles of the claimed subject matter may be employed and the claimed subject matter is intended to include all such aspects and their equivalents. Other advantages and distinguishing features of the claimed subject matter will become apparent from the following detailed description of the claimed subject matter when considered in conjunction with the drawings.

### BRIEF DESCRIPTION OF THE DRAWINGS

FIG. 1 illustrates a block diagram of a sample system for task-related electronic coaching according to aspects of the subject disclosure.

FIG. 2 depicts a block diagram of an example system that monitors user performance of a task and provides suggestive feedback based on task performance.

FIG. 3 depicts a block diagram of an example system tracks user interaction with a network to determine performance of a task according to other aspects.

FIG. 4 illustrates a block diagram of a sample system that provides a visualization of user performance according to additional aspects.

FIG. 5 depicts a block diagram of a sample system that provides predictive user feedback based on organizational goals according to particular aspects.

FIG. 6 illustrates a block diagram of an example system that integrates external benchmarks for evaluating user task performance according to some aspects.

FIG. 7 depicts a flowchart of an example methodology for providing electronic coaching according to still other aspects of the subject disclosure.

FIGS. 8 and 9 illustrate a flowchart of an example methodology for monitoring user interaction with a network to characterize task performance.

FIG. 10 depicts a block diagram of a sample operating environment for providing feedback based on user task performance according to additional aspects.

FIG. 11 illustrates a block diagram of an example remote communication environment for data exchange between remote devices according to further aspects.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, well-known structures and devices are shown in block diagram form in order to facilitate describing the claimed subject matter.

As used in this application, the terms “component,” “module,” “system”, “interface”, “engine”, or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component can be localized on one computer and/or distributed between two or more computers. As another example, an interface can include I/O components as well as associated processor, application, and/or API components, and can be as simple as a command line or a more complex Integrated Development Environment (IDE).

One aspect of personal and enterprise activities involves human training. Typically, individuals require some level of understanding of a field of activity in order to be productive in that field. Whether the field is engineering, sales and marketing, computer system design, small parts manufacturing or any other suitable field of endeavor, accomplishing a task in a particular field requires an understanding of basic principles and experience in implementing that understanding. Accordingly, to be efficient in a field, an individual must be trained or otherwise acquire proficiency in these basic requirements.

One important aspect of human resource organizations, for instance, involves matching individuals for jobs or contract tasks required by an enterprise. Thus, individual skills and experiences must be identified and matched to requirements of a job or task. Although a particular job, such as software design, might require a general set of skills for competency, additional knowledge of a business sponsoring the job is often essential for efficient or effective performance. As an example, where a software product is intended for a particular market consumer, desires and capabilities of the consumer might need to be known in order to design an effective software product. As a further example, where the software product is structured upon a pre-existing software platform, knowledge and experiences of other individuals who constructed the pre-existing platform may be essential in efficiently integrating the software product with that platform. Accordingly, although various jobs and tasks may require a general proficiency in a set of skills, much on-the-job training can also be required considering peculiar aspects and constituents of an organization.

To date, on-the-job training in many fields is conducted manually by individual interaction. An organization might hold or outsource training seminars to teach aspects of a field, or disseminate updated practices or knowledge in the field, which are particular to needs of the organization. Furthermore, work pioneered by individuals within the organization may not be general public knowledge, and thus must be imparted to new hires or contractors employed to build upon those new efforts. In other cases, a particular style or habit of an individual may need to be replicated by other persons performing work for that individual. As an example, an attorney might employ particular legal arguments or contract language tailored to needs of a client. Associates of the attorney would often be expected to match those arguments or language to ensure consistent legal protection and work product for the client. The attorney might instruct his or her associates in aspects of the client's business that generate significant revenue, which require high attention to detail. As another example, the attorney might recognize particular habits of client employees that could surrender legal rights for the client, and instruct associates on how to counsel those employees when engaging in legal work for the client. As this example illustrates, various service or product idiosyncrasies often cannot be taught with general instruction, but require on-the-job training and experience.

Although imparting wisdom to new hires or contractors can be very important, it can also be very time consuming, adding significant overhead to experienced individuals and potentially reducing overall productivity of such individuals. Furthermore, important knowledge is often implicit rather than explicitly defined; in other words, firsthand knowledge can be embedded deeply within personal experiences resulting from various actions, activities or inter-personal interactions, rather than being catalogued and compiled in a reference. Accordingly, automating individual or enterprise training in a field of endeavor can provide significant reduction in overhead, as well as guide a user through actions and activities for understanding the training, in suitable circumstances. Furthermore, by employing cross-over analysis to aggregate experiences and knowledge of multiple individuals compared with peculiar requirements of various tasks, a great degree of precision can be instituted for that training. Furthermore, by monitoring individuals throughout daily work to characterize task performance, gaps in individual understanding or experience can be identified and addressed. Additionally, by monitoring and training multiple individuals in parallel, overall training time for a set of individuals can be minimized.

Although in-house training can be valuable, the training itself is often supplemented by day-to-day personal interactions between members of an organization. Additionally, the quality of these types of interactions can often shape effectiveness of the training or performance of various tasks. Conway's Law characterizes this phenomenon, and states “organizations which design systems . . . are constrained to produce designs which are copies of the communication structures of [the] organizations”. (Conway's Law. Wikipedia, The Free Encyclopedia. 1 Oct. 2008, http://en.wikipedia.org/w/index.php?title=Conway%27s_Law&action=history). Thus, according to Conway's Law, the communication within an organization can limit the scope, nature or quality of the organization's output. Put differently, the effectiveness of inter-personal interaction within the organization can shape the tasks performed by members of the organization. Thus, the quality of inter-personal interactions as well as diversity and richness of a human resource pool available to the organization can affect the success of the organization. Accordingly, effectively leveraging the combined knowledge, skills and experiences of members and other human resources of an organization can be a powerful tool to promote effective training, as well as improve the overall capabilities of existing members.

The subject disclosure provides for automating task-related feedback based on performance of one or more tasks. To determine performance, a network user's interactions with a communication network related to the task can be monitored. Such interactions can comprise communication messages sent among users of the network, where message content is pertinent to the task or a sender/recipient of the message is associated with the task. In other aspects, the interactions can comprise execution of a computer application (e.g., spreadsheet, word processing, presentation, database, or other application) or activities (e.g., executing commands or modules of the application, or data generated or consumed via the application) conducted with the application that produce a result pertinent to the task. In yet other aspects, the interactions can comprise exchanges with members of a social network, including content and context of such exchanges. In other examples, the interactions can comprise device-related monitoring of user personal or physical activity, with content filtering designed to identify aspects of the activity pertinent to the task. Such activity can include person-to-person communications and content or context thereof, biometric sensor data characterizing physical activity, user interaction with an electronic device or type of device, an application or type of application executed at the device, time or frequency based statistics of such activities, and so on.

A model of a user's interactions with a device or network can be generated and filtered to identify interactions pertinent to a task. Data from the filtered model can be further analyzed based on user activity models to build a model characterizing user activity pertinent to a task. Activity or performance goals can be obtained and utilized to establish a baseline task performance model. By comparing user task results with the task performance model, performance of the task based on the user interactions or activities can be determined.

Further to the above, once user task performance is determined, the performance can be compared with a benchmark performance model for the task, to arrive at a disparity between an individual user's performance (or set of users' performances) and a benchmark performance. The benchmark performance model can be trained on prior user performances, including other individuals having worked on the task, members of a common workgroup or team, experts in a field pertinent to the task, and so on. As an example, characterized activities of a set of benchmark users can be aggregated and ranked on performance efficiency, style, or effectiveness in yielding a task goal or other desired result. Variances in interactions of the set of benchmark users can be mapped to differences in the benchmark user performances, where such interactions yield different levels of efficiency, different styles, or different results, or the like. Thus, the performance benchmark for the task can include a spectrum of user interactions or activities corresponding to a spectrum of results for the task.

Once a disparity in an individual's performance compared with the benchmark performance is obtained, the individual's performance can be rated relative the benchmark performance. Suggestive feedback can be provided to the user based on the rating. Thus, for instance, where particular activities, communications, program applications, program toolsets, or the like are employed in producing a more effective or efficient performance of the task, the feedback can suggest employing one or more such activities, etc., or modifying a user's interaction to be consistent with such activities. As one particular example, where benchmark results are achieved based on prior user's interaction with a particular expert or set of experts in a field related to the task, the feedback can recommend conferring with the expert(s) (e.g., to obtain a set of data, instructions or understanding from the expert(s)) and a context for doing so (e.g., activities other users were engaged in when interacting with the expert, questions asked to the expert, and so on).

According to some aspects of the subject disclosure, a user performance model based on previous user interactions can be updated based on current interactions. The updated model can be compared with the benchmark performance (e.g., in real-time or near real-time) and utilized to provide predictive feedback. Thus, for instance, where the updated model indicates a particular gap in user activity related to performing a task, corrective action can be suggested to cover the gap. Accordingly, where sequence-sensitive activities related to the task are employed, the updated model can help to ensure that a particular sequence is followed in accomplishing the task. As a corollary benefit, where a particular sequence is not required but produces a more efficient basis for later user activity, the updated model can increase user efficiency in accomplishing the task. By updating the performance model in real-time or near real-time, suggestive feedback can be provided while a user is engaged in a particular activity to increase effectiveness or accuracy even of short-term activities.

In at least some aspects of the subject disclosure, predictive or preemptive feedback can be provided to a user based on benchmark performance models. For instance, upon assignment of a task to a person, a device or application monitoring the person can trigger generation of a knowledge base of user actions or activities for performing the task from the benchmark performance models. The knowledge base can include identities, aliases or contact information of persons having expertise in a task, as well as a context for that expertise, electronic devices or other equipment configured for or adapted to accomplishing aspects of the task, applications or software tools pertinent to the task, databases having prior communications pertinent to the task, and so forth. Information pertinent to efficiently or effectively completing the task can be compiled from the knowledge base and forwarded to a device/application user as predictive or preemptive assistance or training. In some such aspects, a composition of a social network including the person can be modified or updated to provide a view of persons, devices, tools, etc., pertinent to solving the task and a suggested relationship or association with such persons for efficiently implementing the task. For instance, the composition can generate a team of individuals based on the knowledge base and organize the individuals based on respective experience, skill sets, pertinent technical, communication, management or efficiency traits, or the like.

According to additional aspects of the subject disclosure, a multi-dimensional graphical depiction can be employed as part of the suggestive feedback (or, e.g., the predictive feedback) to expedite consumption of the feedback or illustrate the context of the feedback. For instance, a model of user interactions comprising a user performance model can be depicted to illustrate what the interactions and results of the interactions. Additionally, corresponding benchmark interactions can be provided to enable a user to visualize differences in their activities versus the benchmark model. Furthermore, suggested of modified actions, interactions, activities, etc., can be integrated into the user performance model to enable the user to visualize a suggested performance of the task. Furthermore, predictive analysis can be employed to map predicted results to the integrated user performance model to illustrate results that can potentially be achieved by the suggestions/modifications. Accordingly, the graphical depiction can be employed to increase user understanding of an alternative or preferred method(s) for accomplishing the task, and predicted benefits for employing such method(s).

According to still other aspects of the subject disclosure, individual goals, organizational requirements or additional tasks unrelated or indirectly related with accomplishing a particular task can be integrated into task-related feedback. Associations between such goals/requirements/tasks and the particular task can be established based on defined interests. A context of the particular task can be determined based on the activities and actions of the user in accomplishing the task. Once the context is determined, additional performance benchmarks associated with the context or with tasks pertinent to the context can be referenced to determine appropriate actions for the individual in accomplishing the task or in accomplishing a broader goal of which the task is a part.

For instance, if an individual is utilizing a language instruction application while sending resumes and scheduling job interviews, an inferred context for human language instruction might include augmenting work-related skill sets based on a foreign language or seeking employment in a community that utilizes the language. If, instead, the user is working on the language instruction application in conjunction with a business task unrelated to the language (e.g., a civil engineering project), the inferred context for human language instruction might include interacting with business partners, raw material suppliers, contractors, government officials, or the like, that speak the language. Based on the various contexts, predictive feedback could include job postings for the skill-set(s) in a country where the native population speaks the language, or contact information, web pages, or other information pertinent to suppliers/contractors/officials, etc., in the country.

As another example of cross-related predictive feedback, an individual network and device interactions indicate activity on a software design project task. In addition, communication from the individual indicates a broader platform in which the software is to be integrated, as well as computer-implemented inventive concepts the individual believes are patentable. Based on context of the interactions and content of communications, such goals can be extracted and referenced against related benchmark performance models for an organization. Such models might include performance models for building upon the software platform consistent with existing application programming interfaces (APIs) of the platform, and for obtaining patent rights consistent with an organization's patent licensing strategy, respectively. In the former case, predictive feedback could indicate whether, at a particular point in the design project, the individual is expected to begin generating computer code via one or more APIs to integrate the software design with the broader platform, or compile a presentation of the integration project with expected costs for management review. In the latter case, the predictive feedback could flag sensitive communication or sensitive communication participants that could result in surrendering or limiting patent rights. Although only a small subset of suitable examples for cross-analyzing a task with other tasks, goals or requirements based on user context are articulated herein, it is to be understood that other suitable examples within the scope of the description and appended claims are contemplated as part of the subject disclosure.

In at least one additional aspect of the subject disclosure, benchmark performance models are implemented as exportable/importable entities that can be developed and exchanged with other electronic coaching systems. Such models, once exported, can be imported into a different coaching system and utilized as a standard with which to measure performance of users of the different system. Thus, for instance, where a particular organization or individual has demonstrated success in a field or set of tasks, a demand might exist to train others based on the experience, knowledge, practices or habits employed by the individual/organization in producing the results.

In addition to the foregoing, exportable/importable, or plug-in, benchmark performance models can reduce or eliminate overhead in utilizing an electronic coaching system. For instance, an organization can employ an imported benchmark performance model related to a particular task to train a set of benchmark users on the task. Interactions of the benchmark users can be monitored to develop an independent benchmark performance model for the organization, or modify the imported benchmark model. Once the independent benchmark model matures over time, based on sufficient user monitoring and task results, such model can be exported and utilized throughout the organization, where suitable, or sold, licensed, etc., to external organizations. Thus, employing an electronic system for coaching can be beneficial in generating a market of benchmark models that can be plugged into the coaching system to disseminate effective training models, reduce initial overhead for electronic coaching, or obtain additional revenue.

It should be appreciated that, as described herein, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). The aforementioned carrier wave, in conjunction with transmission or reception hardware and/or software, can also provide control of a computer to implement the disclosed subject matter. Of course, those skilled in the art will recognize many modifications may be made to this configuration without departing from the scope or spirit of the claimed subject matter.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application and the amended claims, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

As used herein, the terms to “infer” or “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

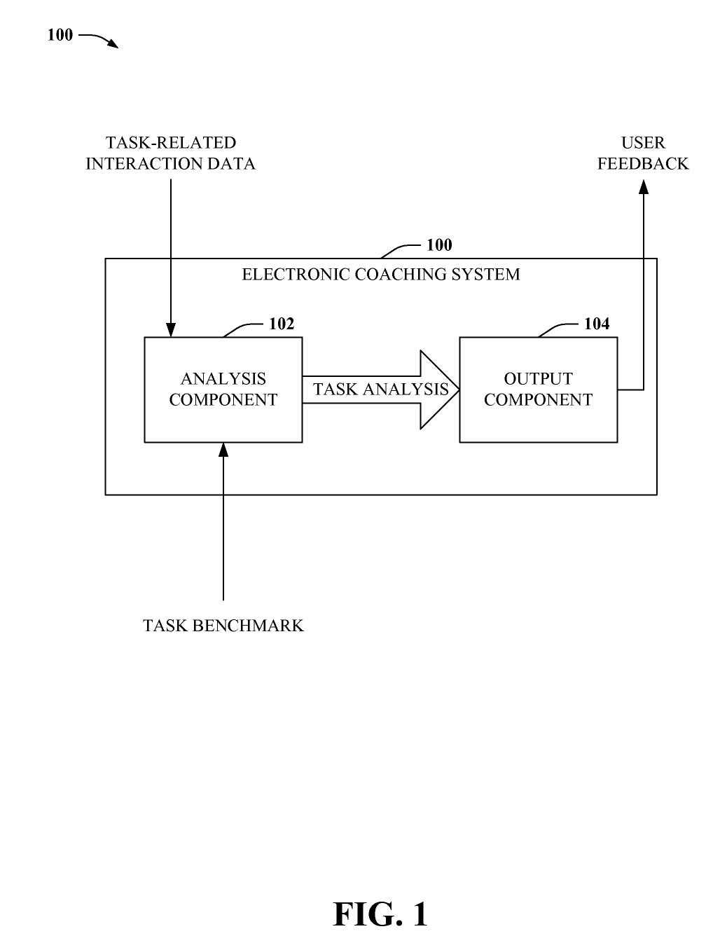

Referring now to the figures, FIG. 1 depicts a block diagram of an example system (100) that provides electronic task-related coaching according to aspects of the subject disclosure. An electronic coaching system 100 can receive task-related user data and output feedback oriented toward assisting in performance of a task, or improving efficiency, effectiveness, accuracy, of task performance. The feedback can be real-time, instructing on desired or proper actions as an individual is working on a task, or periodic, providing feedback based on a summary of activity conducted during a period or previous periods. In another example, the feedback can be predictive, providing instructions upon assignment of the task. Various types of tasks can be monitored and instruction provided by electronic coaching system 100, employing any suitable electronic interface to a computer, electronic device, or network to collect data pertaining to task-related user activity, as described in more detail infra. Accordingly, electronic coaching system 100 can provide a substantial benefit for individuals, decreasing training time based on specific and helpful feedback, as well as organizations, reducing overhead associated with on-the-job training.

Electronic coaching system 100 can comprise an analysis component 102 that employs data pertaining to a user's performance of a task and rates the performance with respect to a task benchmark. Data pertaining to the user's performance can be collected based on user interactions with a communication network or an interface to the communication network. Specifically, the user network/interface interactions can be monitored by an electronic device and utilized to characterize user activity pertinent to the task. The activities and results thereof can be compared with goals or steps in completing the task. By comparison with the benchmark, a rating for the user performance is obtained, which can be included as part of a performance analysis for the task.

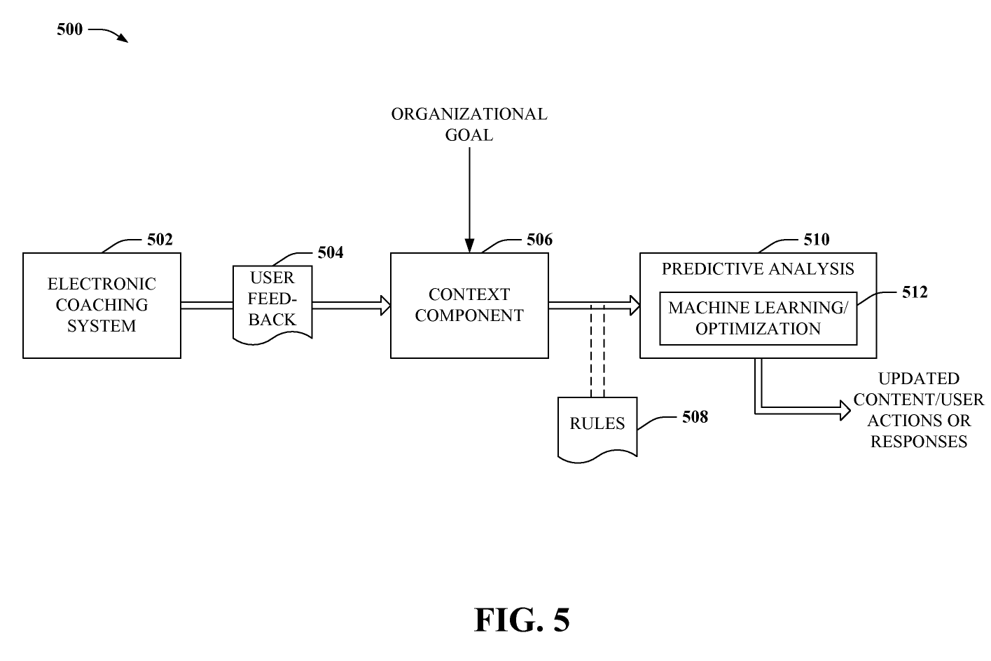

According to one or more aspects of the subject disclosure, user activity can be refined or contextualized based on the user's current context or ambient data associated with a defined user goal or organizational goal (e.g., see FIG. 5, infra). Current context information for the user can include position location, what device/application the user is logged in to, personal status (e.g., on vacation, in a meeting, driving to work, etc.), local weather, time, events, and so on, pertinent to the user's physical context. Additional ambient data can comprise suitable current events, local, national or international market conditions, status of personal, group or organizational conditions relative one or more goals (e.g., current stock price of a company, current sales v. target sales, and so on). Such data can be utilized to characterize user activity, as well as performance of a particular task, as discussed below.

In some aspects of the subject disclosure, the communication network can comprise an electronic social network, which enables users to store contextual information pertaining to themselves (e.g., social, professional or familial interests, current or past activities or future goals, experiences, training and skills, hobbies, and so on), track electronic communications between users of the network and a context of such communications, or map users and user interactions based on frequency, content or context of such interactions. In such aspects, data or message content shared between users of the electronic social network can be analyzed to determine whether the data is pertinent to a task the user is working on. Relevancy of the data/content to the task can be utilized to rate the interaction in terms of accomplishing the task. Alternatively, or in addition, other users' knowledge, expertise or experience with the task can be analyzed to rate the interaction relative performance of the task.

In other aspects of the subject disclosure, the communication network can comprise a messaging network, such as an instant message (IM) network, short message service (SMS) network or other network suitable for electronically exchanging text between user devices (e.g., mobile phones, computers, laptop computers, personal digital assistant, etc.). In yet other aspects, the communication network can comprise a voice communication network, such as a telephone network, mobile phone network or the like. Speech to text analysis can be employed to digitize and record verbal communication, which can be analyzed for context pertaining to the task. According to still other aspects, the communication network can comprise the Internet, an enterprise intranet, or other suitable platform for data exchange between remote electronic devices. In such aspects, an e-mail application can be monitored for message content pertaining to the task or message participants having experience/expertise in the task. Additionally, user use of various computer applications can be monitored to identify user interactions and activities pertaining to the task. Execution and/or use of data manipulation applications, such as database applications, spreadsheet applications, word processing applications, computer-aided drawing (CAD) applications, as well as customized task-related software (e.g., program development software, engineering analysis software, fashion design software, building and construction visualization software, and so on) or task related electronic devices (e.g., surveying equipment, construction equipment, automated manufacturing equipment, exercise equipment, navigation instruments, media recording or playback equipment, etc.) can be monitored to collect a rich data set for characterizing user activities pertinent to accomplishing a task.

In addition to the foregoing, results of user interactions pertaining to the task can be included in the task-related interaction data. Results can include, for instance, whether a project was successfully completed, whether or what portions are successfully completed, a degree of completion thereof (relative a benchmark), effectiveness or efficiency in completing the project or portions, compared with effectiveness/efficiency models derived from the benchmark, or the like. The results can additionally include time required to complete the task as well as time-based statistics, such as number of user interactions required to complete the task, time to complete each interaction, time to arrive at one or more target completion measures, degree of success in effecting the target completion measures, or the like. Correlations between actions taken and produced results can also be included in the data. Example correlations can be time-based correlations (e.g., a set of interactions taken between one measure of completion and a subsequent measure), task-based correlations (e.g., sequences of completion measures), and so on. Various mechanisms can be implemented to track such data, including user-established completion measures (e.g., provided by the individual working on the task, or a task manager) or automatically determined completion measures based on task analysis pertaining to other users or related tasks.

The raw interaction/activity, result or correlation data is obtained by analysis component 102. Analysis component 102 can parse the data in order to generate a performance model for a user of the electronic coaching system 100. Such a model correlates the interactions or context of the interactions with various task results. The model can then be compared with a benchmark model to rate the user's performance of the task relative to the benchmark. The rating can comprise an overall rating pertinent to advancing the task, or multiple ratings for advancing various aspects of the task (e.g., based determined completion measures). The interaction data, result data and completion ratings are compiled into a task analysis for the user and provided to an output component 104, for predictive guidance or suggestive feedback.

Output component 104 employs the performance ratings and determines user activities/interactions associated with the performance benchmark to identify aspects of a task where improved user performance can be obtained. For instance, where a particular completion measure is rated lower than a corresponding completion measure of the benchmark performance, differences in user interactions and associated benchmark interactions can be identified. The differences can be utilized to construct a modified set of interactions for the user. Alternatively, or in addition, the differences can be utilized to plan future interactions for the user to improve subsequent performance of the task. Output component 104 can recommend one or more interactions, activities, etc., to take or other users to contact, in subsequent iterations of the task, as a mechanism to guide current task performance, train future task performance, or to take in future aspects of the task, as a predictive coaching tool. Accordingly, electronic coaching system 100 can provide specific recommendations for the user based on benchmark performance models to improve user efficiency, output or effectiveness. Where the performance benchmark is based on a diverse and rich set of user interaction data, electronic coaching system 100 can improve on typical task-related limitations (e.g., based on communication structures of an organization, as illustrated by Conway's Law, supra).

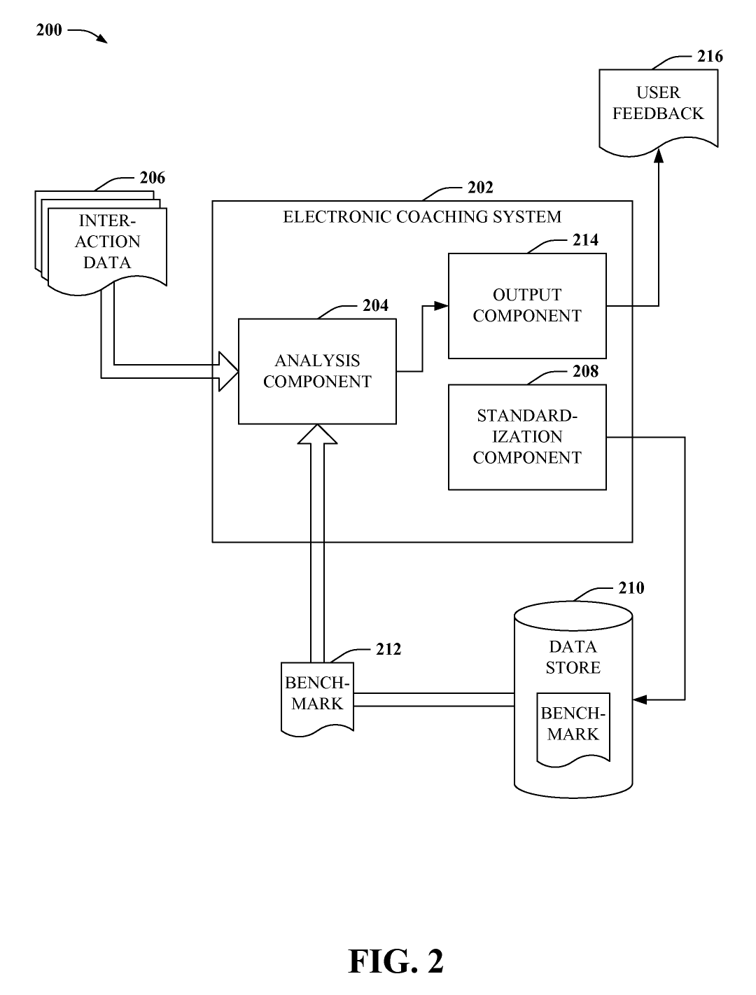

FIG. 2 depicts a block diagram of an example system 200 that employs task-related user activity models in providing suggestive feedback for a task according to particular aspects of the subject disclosure. System 200 comprises an electronic coaching system 202 that can obtain user activity models (e.g., characterized from user interactions with an electronic device, communication network, electronic social network, or the like) pertaining to a task and output suggested feedback for guiding or improving task-related performance. The feedback is based on a performance benchmark obtained from a control set of system users. Where a diverse and rich set of control data is available for the performance benchmark, the feedback can be helpful in identifying performance inefficiencies and enabling diverse and effective results.

Electronic coaching system 202 comprises an analysis component 204 that obtains task-related user activity or device/network/application interaction data, including user interactions, activities or communications associated with a task, and outputs a task analysis. To provide the output, analysis component 204 can construct a performance model for a user based on task-related interaction or activity models, and task result models. The performance model is compared with a benchmark performance model constructed from benchmark user activities or device/network/application interactions pertaining to the task or related tasks, and results of such benchmark actions or interactions.

Benchmark performance data 212 can be compiled by a standardization component 208, and stored in a data store 210. Such data can include task-related activities of a control set of users for a task, and results for those activities, optionally as a function of one or more of the control set of users, groups or teams of such users, or the like. The benchmark performance data can provide a standard for which other users of system 200 can be rated to facilitate suggestions on improving performance.

Output component 214 obtains an analysis of user performance versus the benchmark performance from analysis component 204, and provides suggestive feedback calculated to improve user performance relative to the benchmark performance. For instance, where a user performance is rated relatively low compared to the benchmark performance, interactions and activities taken by the user can be modified based on activities/interactions of the control set of users. Alternatively, or in addition, new interactions/activities can be identified, optionally in a particular sequence, to provide out-of-the-box analysis and determination for the user. The modified or additional interactions can be output to a user feedback file 216, and provided to a user interface application for user consumption (e.g., graphical display, audio file translated by a text-to-speech program, spreadsheet, word processing document, or the like).

Alternatively, or in addition to the foregoing, output component 214 can access a task knowledge base (not depicted) generated from the benchmark performance to provide predictive output for guiding performance of the task. The feedback can include suggested persons, tools, software, databases or instructions for accomplishing the task, based on a performance benchmark model, and optionally based on characteristics or traits of a user determined from prior user task performance, performance analysis, or coaching. The feedback can be included in the user feedback file 216 and output for user consumption, as discussed herein.

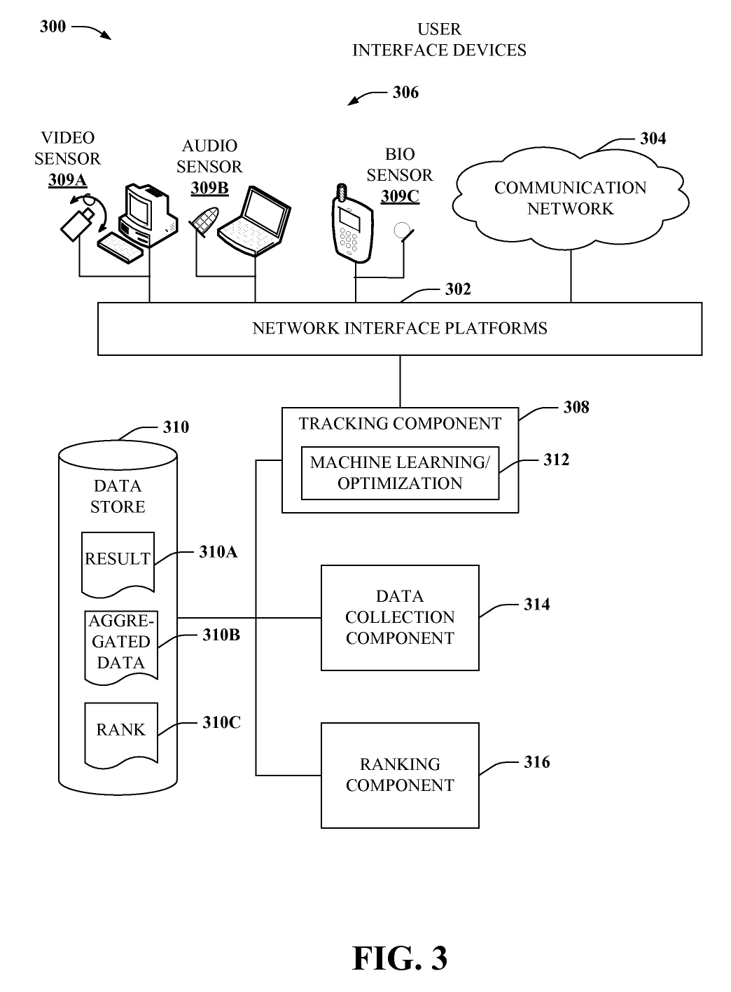

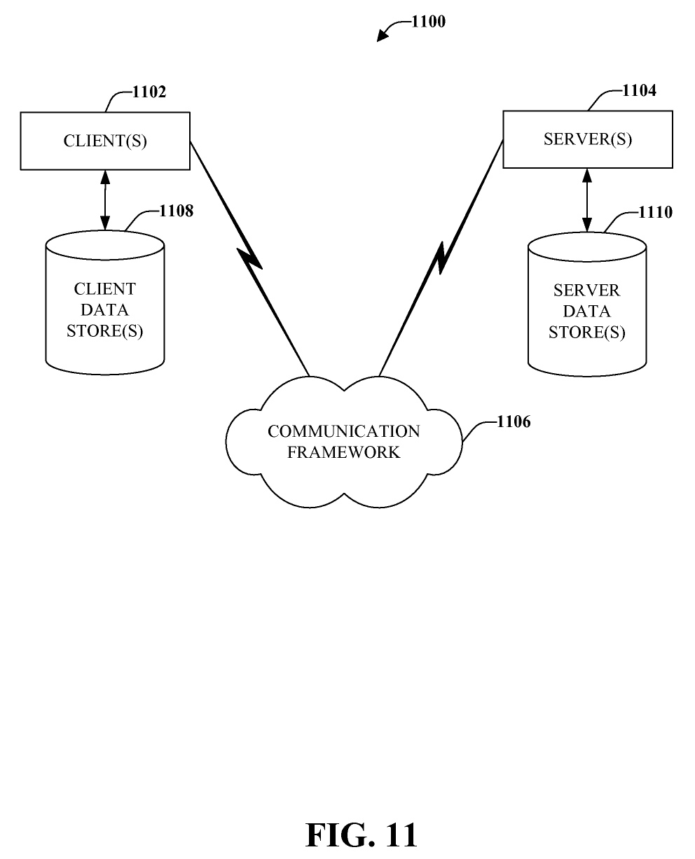

FIG. 3 depicts a block diagram of an example system 300 for collecting task-related user interaction data and compiling user or benchmark performance models for a task. System 300 comprises a set of network interface platforms 302 coupled with a communication network 304. The interface platforms 302 provide wired or wireless inter-connectivity between one or more electronic user interface devices 306. The interface platforms 302 can comprise e-mail, IM, SMS, voice, or other communication architectures, located separately on the user interface devices 306 (e.g., in a peer-to-peer remote communication arrangement), separate from the devices 306 (e.g., in an externally routed remote communication arrangement, such as an access point), or both. Thus, for instance, individual interface applications (e.g., e-mail, IM, etc.) can reside on the interface devices 306, and an external server (not depicted, but see, e.g., FIG. 11, infra) can be employed to facilitate communication between the devices or with the network 304. According to at least some embodiments, the network interface platforms 302 can provide a common communication standard for task-related applications executed at the interface devices 306. For instance, a universal serial bus (USB) platform, or a like wired or wireless communication standard, could provide inter-communication between engineering programs, marketing, program development, social networking, and so on, executed at the devices 306.

Additionally, system 300 can comprise a tracking component 308 that monitors the user interactions with the network interface platforms 302, network 304, or with applications executed at the interface devices 306, to construct task-related activity models for a user. The activity models can be constructed based on usage-models and usage histories of the user or a set of users, optionally as a function for various devices 306 or device applications or systems, interface platforms 302 or networks 304. Furthermore, the usage models can be supplemented with ambient contextual information or user stimuli-response information, captured by a set of ambient sensors 309A, 309B, 309C. The captured information can be employed in determining user response to task-related instructions, measure ambient noise (e.g., to characterize potential distraction), define user position location, determine temperature, or the like. Examples of various ambient sensors include a video capture component 309A, an audio capture component 309B, and biometric sensor 309C, although it should be appreciated that various other suitable sensors can be employed in capturing information pertaining to a user's current physical context.

As specific examples, a video capture component 309A can capture video information pertinent to the user to analyze user actions (e.g., in response to task-related guidance or feedback), or physical responses (e.g., movements to indicate action, shaking to indicate nervousness or indecision, pupil dilation to indicate strong emotion, etc.). As another example, an audio capture component 309B can be employed to capture speech, non-articulate sounds, background noise, or the like. Additionally, biometric sensors can be employed to measure heart-rate, blood pressure, or other biometric responses of a user. In general, the sensors can be employed to collect data pertaining to various physical actions and responses of a user, to characterize user activities related to task-performance or task-response, as described herein.

Further to the above, tracking component 308 can compile task-related activities or interactions each device (306) or device user, as a function of a particular task or set of related tasks. In addition, results of the task(s) can be identified and compiled with the task-related instructions, and stored in an interaction-result file 310A in a data store 310. Results of the tasks can be correlated to activities/interactions producing such results, in order to create an interaction-result performance model. Such a model can be constructed for individual devices (306)/device users and for a control group of devices/device users (306) utilized to establish a performance standard for the task(s). Thus, for instance, a data collection component 314 can aggregate network interaction and result data for a plurality of control group users. The aggregated data can be correlated per user, per group/team of users, or per task. Tracking component 308 can employ the aggregated data in generating a performance benchmark utilized for standardizing user interactions and results, and generating feedback.

In some aspects of the subject disclosure, machine learning and optimization 312 can be employed to identify task-related interactions and results, and construct the interaction-result models. The models can be optimized over multiple interactions and aggregated to accurately associate task interactions with task results. Additionally, based on comparison of user and benchmark models feedback can be optimized over successive feedback-interaction-result analysis to generate effective feedback particular to a task and a user of an electronic coaching system. Thus, machine learning and optimization component 312 can utilize a set of models (e.g., interaction-result model, user use history models, feedback-result loop model, user statistics model, etc.) in connection with determining or inferring user task performance, constructing a user performance model, and providing suggestive feedback to improve user performance. The models can be based on a plurality of information (e.g., user interaction patterns, task results, benchmark interaction patterns, successive optimizations thereof, etc.). Optimization routines associated with machine learning and optimization component 312 can harness a model that is trained from previously collected data, a model that is based on a prior model that is updated with new data, via model mixture or data mixing methodology, or simply one that is trained with seed data, and thereafter tuned in real-time by training with actual field data based on parameters modified as a result of error correction instances.

In addition, machine learning and optimization component 312 can employ machine learning and reasoning techniques in connection with making determinations or inferences regarding optimization decisions, such as matching suitable feedback for particular users based on user interaction histories. For example, machine learning and optimization component 312 can employ a probabilistic-based or statistical-based approach in connection with identifying and/or updating task-related feedback based on similar data collected for a plurality of users. Inferences can be based in part upon explicit training of classifier(s) (not shown), or implicit training based at least upon one or more monitored results, and the like.

Machine learning and optimization component 312 can also employ one of numerous methodologies for learning from data and then drawing inferences from the models so constructed (e.g., Hidden Markov Models (HMMs) and related prototypical dependency models, more general probabilistic graphical models, such as Bayesian networks, e.g., created by structure search using a Bayesian model score or approximation, linear classifiers, such as support vector machines (SVMs), non-linear classifiers, such as methods referred to as “neural network” methodologies, fuzzy logic methodologies, and other approaches that perform data fusion, etc.) in accordance with implementing various aspects described herein. Methodologies employed by optimization module 312 can also include mechanisms for the capture of logical relationships such as theorem provers or heuristic rule-based expert systems. Inferences derived from such learned or manually constructed models can be employed in other optimization techniques, such as linear and non-linear programming, that seek to maximize probabilities of error. For example, maximizing an overall accuracy of successive user interaction-result instances for a producing a desired task result can be achieved through such optimization techniques.

Tracking component 308 can comprise a centralized architecture, coupled with the network interface platforms 302, or distributed architecture, located at one or more of the interface devices 306, or both. Thus, data can be collected at individual devices and submitted to a central controller, or obtained in response to queries from such controller. Data compiled by tracking component 308 is stored in data store 310 for reference by an electronic coaching system, as described herein (e.g., see FIGS. 1 and 2).

In addition to the foregoing, system 300 can comprise a ranking component 316 that rates a user with respect to a set of users (e.g., a user control group, new employee group, common taskforce, team, workgroup, etc.). The ranking can be based on efficiency in which interactions employed by a user produce a task result compared with task results of a subset of the set of users. The ranking can be stored in data store 310 in a ranking file 310C, which can be output to an electronic coaching system to determine a degree of performance disparity among sets of users.

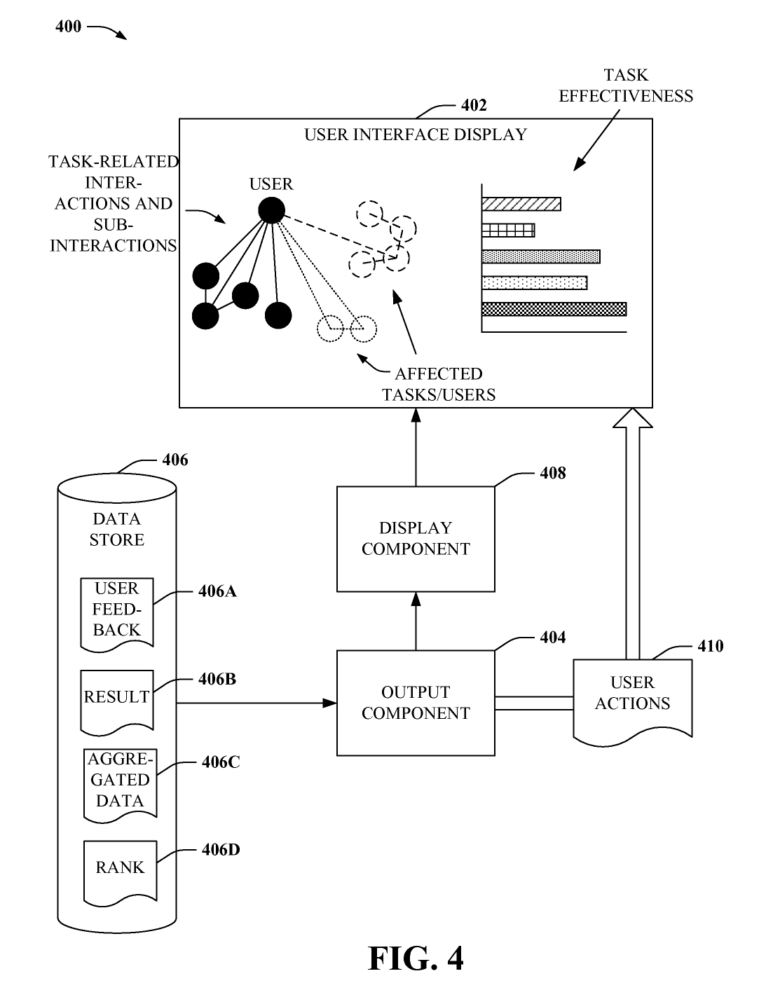

FIG. 4 depicts a block diagram of an example system 400 that provides multi-dimensional graphical output of suggestive feedback, to expedite consumption of the feedback. System 400 can comprise an output component 404 that organizes suggestive feedback data 406A for a user of an electronic coaching system. The organized feedback data is submitted to a display component 408 that encodes the data for graphical rendering at a user interface display 402.

In some aspects of the subject disclosure, output component 404 can organize feedback data 406A in a manner that illustrates analyzed interactions employed by a user in accomplishing the task. In many circumstances, users can forget specific interactions or communications employed in conjunction with accomplishing a task, especially where many such interactions/communications exist. Thus, in at least one aspect, the illustration can provide an effective review of user activity pertaining to a task.

The interaction illustration can depict relationships between the user and one or more resources (e.g., tools, applications, devices, or other system users) leveraged by the user. As one example, the user and resources can be depicted as nodes in the display 402 (e.g., solid circles of user interface display 402), with user-resource interactions depicted as connections between the nodes. Proximity of the nodes can indicate a number or frequency of interactions, importance of interactions to accomplishing the task (e.g., determined from a benchmark performance model), or the like. Additionally, content of the interactions can be analyzed to determine a context thereof (e.g., indicating an aspect of a task associated with a particular interaction, or a goal of an interaction input by the user, etc.). The depiction can be annotated with context information to provide a more complete user interaction history for the graphical display 402. In other aspects, task results 406B can be depicted via bar graphs, pie charts, line charts, and so on, to compare results among various users. The graphs can be annotated with a user ranking 406D that quantifies differences in user performances. Thus, such an organization of interaction data can depict a history of task-related user-resource interactions for a task, illustrating an overview of the user's interaction history and effectiveness in accomplishing one or more tasks or task results 406B as compared with other such users.

According to other aspects of the subject disclosure, aggregated benchmark user-resource interactions 406C of a task-related performance benchmark can also be depicted at user interface display 402. The benchmark interactions can be displayed relative the user's interaction-resource display, in order to depict differences in a manner in which the user attempted to accomplish a task as compared with a control set of benchmark users. Additionally, suggested user actions 410 can also be depicted at the user interface display 402. The suggested user interactions can be integrated into the user interaction-result display, to provide a complete depiction of past interactions and suggested future actions (or, e.g., modifications of past interactions for subsequent task performance).

According to yet other aspects, output component 404 can compile external resources (e.g., sets of users, applications, devices, tools related or independent from the user or task, depicted at user interface display 402 by dotted and dashed nodes) affected by the user's interactions. Thus, as an example, the display could indicate where utilization of a resource reduces a time that the resource is available for other users or other tasks. As another example, the display could indicate where expertise or knowledge provided by the user affected task performance of the external users. Such results can be updated to the display as annotated data to provide context for the external interactions and results. External analysis can be useful in determining how interaction between members of an organization, as a whole or in selective parts, affects task results. In at least some aspects of the subject disclosure, an electronic coaching system could employ such analysis in suggesting different organizational structures to improve efficiency of the organization, or expand on the effectiveness of the members in designing systems (e.g., based on Conway's Law, supra).

FIG. 5 illustrates a block diagram of an example system 500 for providing task-related predictive feedback or guidance according to aspects of the subject disclosure. System 500 can comprise an electronic coaching system 502 that analyzes user interactions with device, network or user resources and provides feedback 504 to improve task-related performance, as described herein. In addition, electronic coaching system 502 can output the user feedback 504 to a context component 506 that determines a relationship of the task with a personal or organizational goal. Such a goal can be input by an external source (e.g., organization manager, executive, travel agent) or inferred from user interaction histories, inter-user communication content, or the like. In some aspects, the goal can be a performance goal for completing a task. In other aspects, the goal can be unrelated to performance of the task, being based on a different but related goal of an individual or organization. For instance, where a task involves designing a product for a business, the organizational goal could include leveraging other existing products with the product design, maintaining an open-ended design architecture for integration with future products, identifying a market for the product, obtaining management approval for the design, identifying sources of funding for the product design, securing or preserving patent rights for the product, and so on.

Based on the user feedback 504 and organizational goal, the context component 506 can further define a set of rules 508 for performing the task consistent with the goal. In some aspects, the rules 508 can be optimized (e.g., by machine learning and optimization 512) based on successive user interactions or task performances and impact of such interactions/performances on the organization goal. Alternatively, or in addition, the rules can also be optimized based on current context or events pertinent to the user, set of users, or an organization or group associated with the goal. The current context can include a personal context of the user (e.g., calendar schedule, personal status, communication device/application currently logged on to), physical context of the user (e.g., position location, current time, local weather, local traffic conditions, etc.), and so forth. Additionally, the rules can be subject to various current events, data or conditions pertinent to the user or organization. Such current events/data/conditions can be collected by a data mining server (not depicted, but examples can include an Internet search engine, private search engine, or the like) and output to the context component 506 for comparison with defined data thresholds or conditions associated with the goal.

System 500 can further comprise a predictive analysis component 510 that modifies the user feedback 504 consistent with the set of rules 504. Modification can comprise highlighting or flagging important aspects of the feedback 504, along with how the feedback might affect the organizational goal. Alternatively, or in addition, modification can comprise flagging sensitive aspects of the feedback 504 along with potential concerns related to violating a rule, indicating the rule, and the context for the rule in respect of the feedback 504. In other aspects, modification can comprise changing the suggestive feedback to be more consistent with the organizational goal. Predictive feedback 510 can employ machine learning and optimization 512, as described herein, to identify goals associated with a particular user interaction and match feedback modifications to expected results of the interaction in view of the rules 508.

As a particular example to illustrate the foregoing, consider a task and user interactions associated with the above product design. A related organizational goal in this context can pertain to obtaining patent rights for the resulting product. Rules 508 can be generated based on requirements for maintaining secrecy of inventive aspects of the product, to avoid a public disclosure affecting patent rights. Where user feedback 504 comprises initiating a communication with an expert in product design, the predictive analysis component 510 can determine whether content of the communication might reveal the inventive aspects, and whether such revelation would maintain the secrecy requirement. Thus, for instance, the modified feedback could flag sensitive content and suggest removing the content for the communication with the product design expert, if the expert is not under non-disclosure agreement. Alternatively, the modified feedback could recommend another expert under obligation to assign patent rights, under non-disclosure agreement, or other suitable action determined to be consistent with an identified goal.

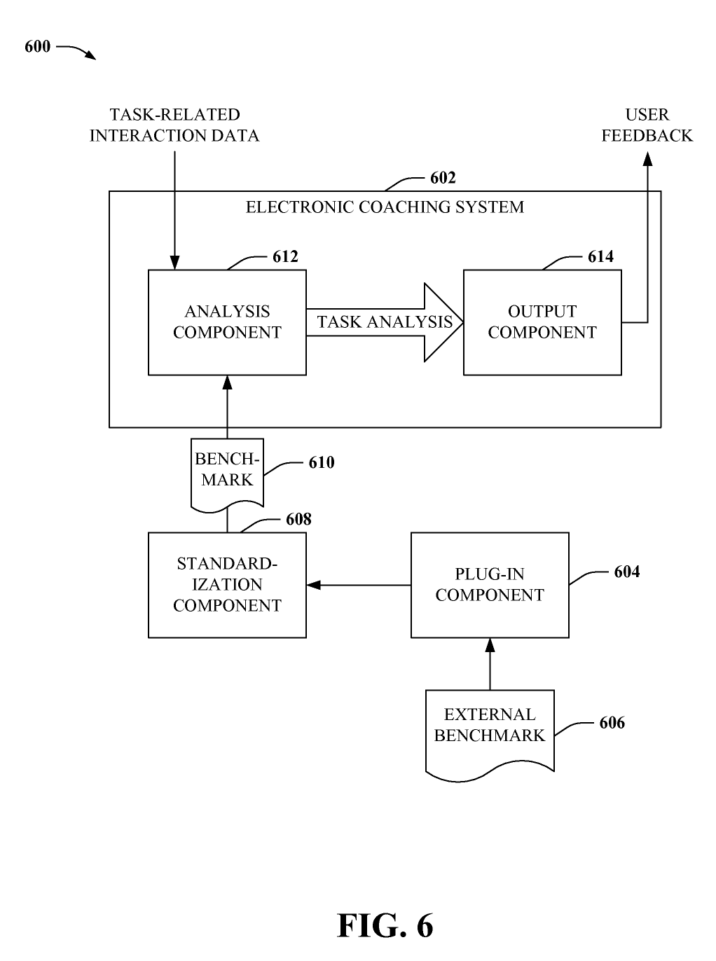

FIG. 6 depicts a block diagram of an example system 600 that provides plug-in benchmark performance models that can be integrated into an electronic coaching system 602. The plug-in benchmark models can be written to an application file that can be exported from one such system 602 and imported to another (602). System 600 comprises a plug-in component 604 that obtains such an external benchmark file 606. The plug-in component 604 can reconfigure the external benchmark file 606, as necessary, to be integrated into the electronic coaching system 602. Reconfiguration can comprise file modification, language modification of user input/output files, activating or deactivating text-to-speech or speech-to-text applications, audio codecs, video codecs, or other suitable applications associated with the external benchmark file 606, based on capabilities of the electronic coaching system 602, or a device executing the system (not depicted).

The modified external benchmark (606) can be provided to a standardization component 608 that maintains sets of such external benchmarks. The standardization component 608 can select a suitable benchmark for a task, organization, or goal identified by a user of the electronic coaching system 602. The selected benchmark 610 is provided to an analysis component 612 for reference in determining effectiveness or efficiency of task performance as described herein. Suggestive feedback can be generated by an output component based on the task performance and one or more performance interactions contained within the selected benchmark 610.

As described, system 600 can provide significant utility for the electronic coaching system 602. For instance, system 600 can reduce overhead required in generating benchmark models for the user or for an organization based on internal user task analysis. Thus, the coaching system 602 can provide task analysis for the organization shortly after initial implementation. Additionally, system 600 can provide cross-organizational analysis employing benchmark models generated by organizations having successful task results. Such models can be utilized in providing feedback based on the successes of the organizations. As a result, overhead in cross-training among various organizations or individuals can be significantly reduced by system 600.

The aforementioned systems have been described with respect to interaction between several components. It should be appreciated that such systems and components can include those components or sub-components specified therein, some of the specified components or sub-components, and/or additional components. For example, a system could include electronic coaching system 102, interface devices 306, tacking component 308, context component 506 and predictive analysis component 510, or a different combination of these and other components. Sub-components could also be implemented as components communicatively coupled to other components rather than included within parent components. Additionally, it should be noted that one or more components could be combined into a single component providing aggregate functionality. For instance, tracking component 308 can include data collection component 314, or vice versa, to facilitate tracking and aggregating interaction and task result data of multiple users by way of a single component. The components may also interact with one or more other components not specifically described herein but known by those of skill in the art.

Furthermore, as will be appreciated, various portions of the disclosed systems above and methods below may include or consist of artificial intelligence or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, and in addition to that already described herein, can automate certain mechanisms or processes performed thereby to make portions of the systems and methods more adaptive as well as efficient and intelligent.

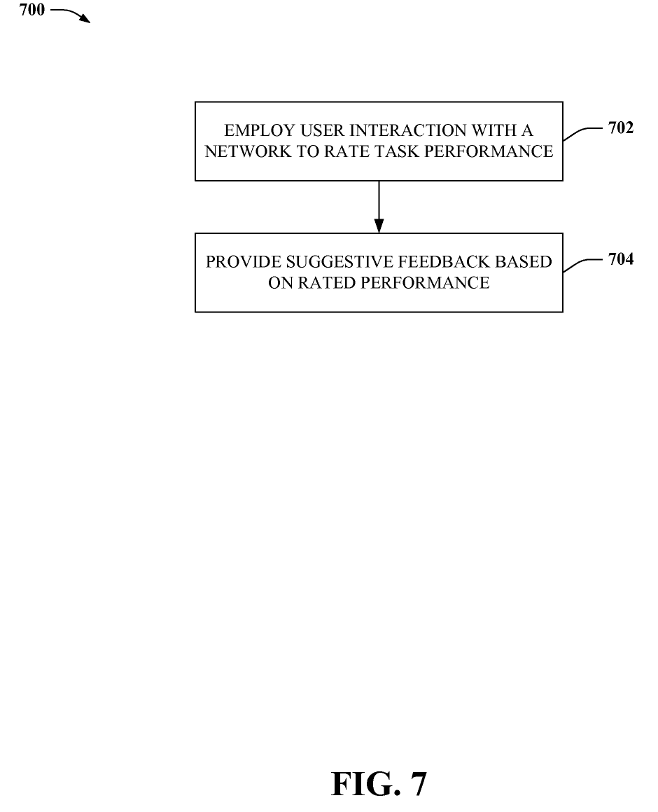

In view of the exemplary systems described supra, methodologies that may be implemented in accordance with the disclosed subject matter will be better appreciated with reference to the flow charts of FIGS. 7-9. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter. Additionally, it should be further appreciated that the methodologies disclosed hereinafter and throughout this specification are capable of being stored on an article of manufacture to facilitate transporting and transferring such methodologies to computers. The term article of manufacture, as used, is intended to encompass a computer program accessible from any computer-readable device, device in conjunction with a carrier, or media.

FIG. 7 depicts a flowchart of an example methodology 700 for providing electronic coaching according to aspects of the subject disclosure. At 702, method 700 can employ user interactions with a communication network, or users of the communication network, to identify user activity pertinent to a task and rate performance of the task. The rating can be based on a comparison of individual user interaction or activities and results of such interactions/activities with a benchmark interaction-result model. Such model can be trained on prior device/network interactions and associated activity models of a control set of users in performing the task or a related task. Additionally, machine learning and optimization can be employed to refine user interaction-result models and the benchmark models based on successive user interactions/activities and task results.

At 704, method 700 can provide suggestive feedback based on the rated performance. The suggested feedback can be determined from a comparison of user interaction-result models and corresponding benchmark models for a task or set of tasks. Instances where user interactions produce a less than desired result can be identified and compared with corresponding actions of the benchmark models. Differences in interactions can be identified and provided as part of the feedback. Additionally, the feedback can include an illustration of the differences to facilitate user understanding of the benchmark and the feedback and its predicted effectiveness in producing desired task results.

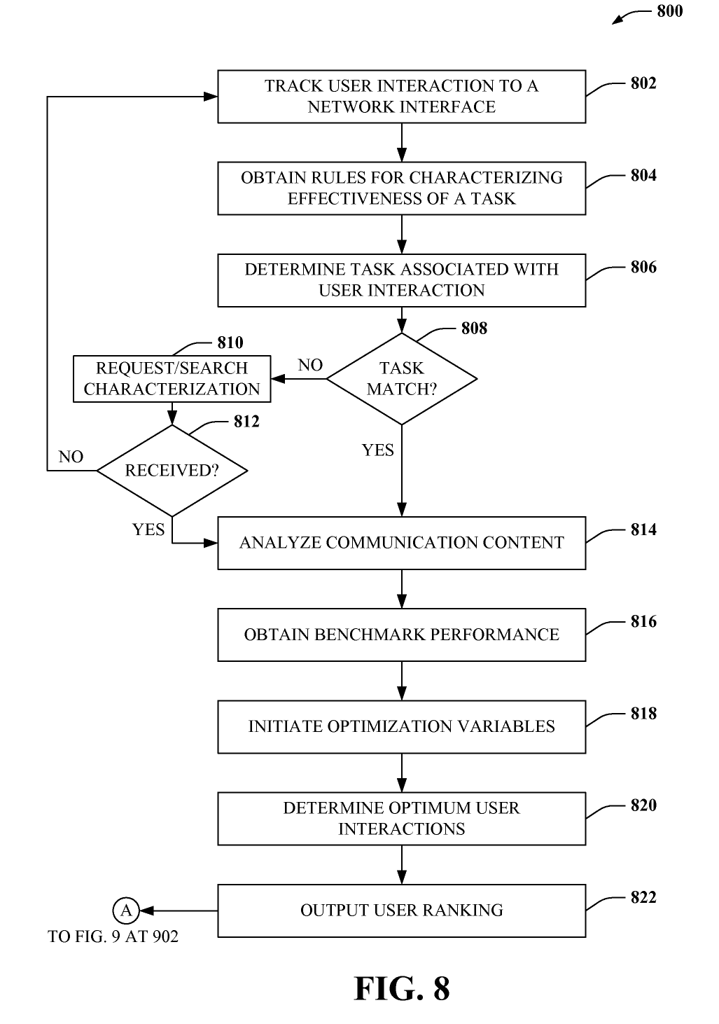

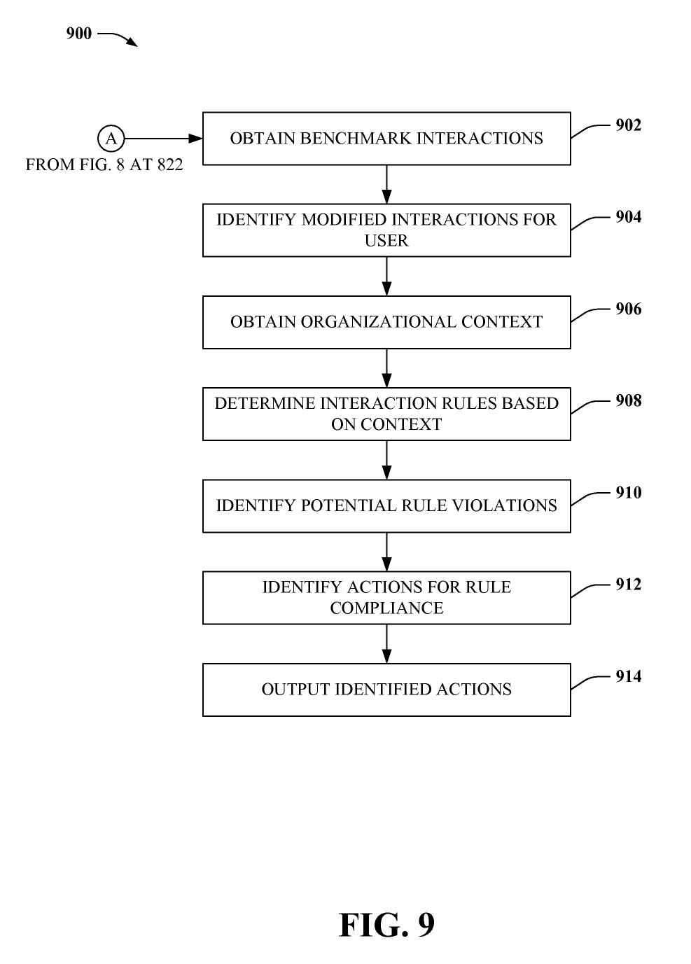

FIGS. 8 and 9 depict flowcharts of example methodologies 800, 900 for employing user interactions with communication networks or users of such networks in providing task-related coaching. Specifically, methodology 800 can analyze user interactions pertaining to a task and provide a performance rating for the task. Methodology 900 can employ the performance rating and identify specific interactions, communication or activities that can be undertaken by a user to improve performance, effectiveness or efficiency of the task. Accordingly, the methodologies provide a substantial benefit in automating user training for a set of tasks.

Referring to methodology 800, at 802, method 800 can track user interaction with a network or an interface to the network. At 804, method 800 can obtain rules for characterizing effectiveness of a task. The rules can be based on prior user task performances, or can be models trained on seed data, which are updated based on subsequent user task analysis. At 806, method 800 can determine a task associated with the user interaction. Such determination can be based on language processing analysis of content of the interaction, or by explicit input by a user of the network. At 808, method 800 can determine whether the task matches the rules characterizing effectiveness of the task. If not, method 800 can proceed to 810, where rules are requested from the user or searched from a data store or other network storage entity. At 812, method 800 can determine whether the requested/searched rules or obtained. If not, method 800 returns to 802; otherwise, method 800 can proceed to 814. If the identified task does match the characterizing rules, method 800 can also proceed from the determination at 812 to 814.

At 814, method 800 can analyze communication content associated with tracked user interactions with the network or network interface. At 816, method 800 can obtain a benchmark performance model. At 818, method 800 can initiate optimization of variables characterizing the user interactions relative to benchmark interactions of the benchmark performance model. At 820, method 800 can determine an optimum set of interactions for the user to maximize performance of the task. At 822, method 800 can output a user ranking of the task performance, based on a comparison of the user interaction and benchmark performance model. Method 800 can proceed to reference number 902 of methodology 900, to provide specific feedback for improving user task performance.

Referring to methodology 900, at 902, method 900 can obtain a set of benchmark interactions based on comparison of a user's performance model with a benchmark performance model. At 904, method 900 can identified modified user interactions for the user to improve performance of a task. At 906, method 900 can obtain an organizational context associated with the task or affected by the task. At 908, method 900 can determine interaction rules for the organizational context. At 910, method 900 can identify potential rule violations for the modified user interactions based on the interaction rules. At 912, method 900 can identify substitute or modified actions consistent with the rules. At 914, method 900 can output the substitute/modified interactions for user consumption.

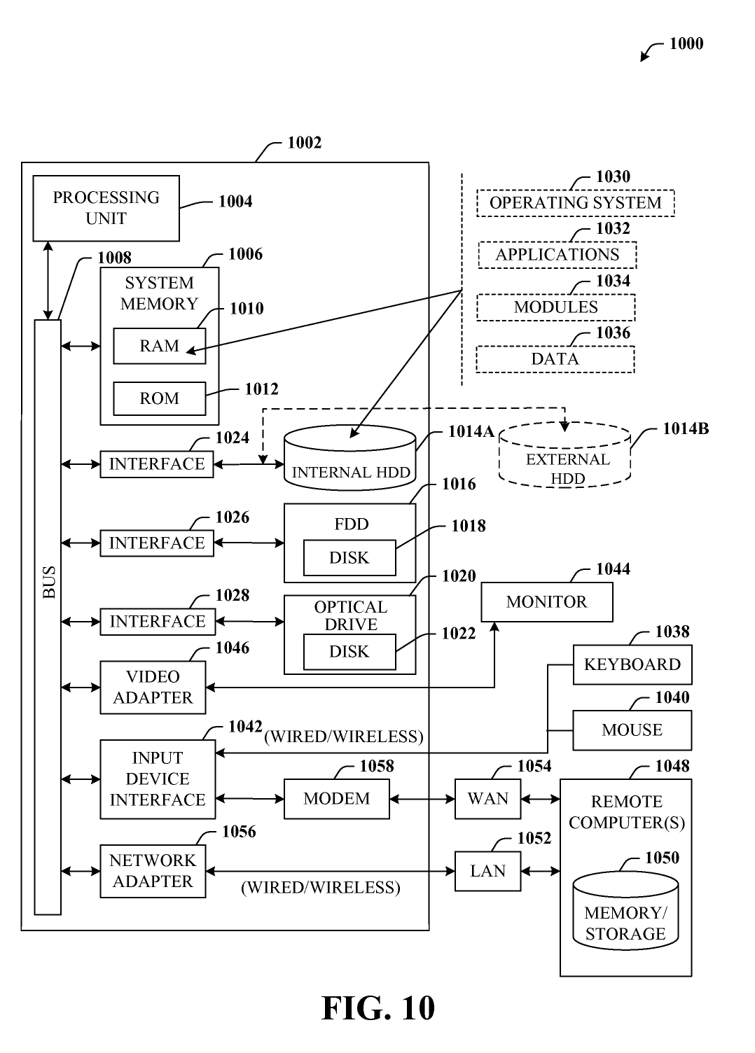

Referring now to FIG. 10, there is illustrated a block diagram of an exemplary computer system operable to execute the disclosed architecture. In order to provide additional context for various aspects of the claimed subject matter, FIG. 10 and the following discussion are intended to provide a brief, general description of a suitable computing environment 1000 in which the various aspects of the claimed subject matter can be implemented. Additionally, while the claimed subject matter described above can be suitable for application in the general context of computer-executable instructions that can run on one or more computers, the claimed subject matter also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the claimed subject matter can also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media can include both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

Continuing to reference FIG. 10, the exemplary environment 1000 for implementing various aspects of the claimed subject matter includes a computer 1002, the computer 1002 including a processing unit 1004, a system memory 1006 and a system bus 1008. The system bus 1008 couples system components including, but not limited to, the system memory 1006 and the processing unit 1004. The processing unit 1004 can be any of various commercially available processors. Dual microprocessors and other multi-processor architectures can also be employed as the processing unit 1004.

The system bus 1008 can be any of several types of bus structure that can further interconnect to a memory bus (with or without a memory controller), a peripheral bus, and a local bus using any of a variety of commercially available bus architectures. The system memory 1006 includes read-only memory (ROM) 1010 and random access memory (RAM) 1012. A basic input/output system (BIOS) is stored in a non-volatile memory 1010 such as ROM, EPROM, EEPROM, which BIOS contains the basic routines that help to transfer information between elements within the computer 1002, such as during start-up. The RAM 1012 can also include a high-speed RAM such as static RAM for caching data.

The computer 1002 further includes an internal hard disk drive (HDD) 1014A (e.g., EIDE, SATA), which internal hard disk drive 1014A can also be configured for external use (1014B) in a suitable chassis (not shown), a magnetic floppy disk drive (FDD) 1016, (e.g., to read from or write to a removable diskette 1018) and an optical disk drive 1020, (e.g., reading a CD-ROM disk 1022 or, to read from or write to other high capacity optical media such as the DVD). The hard disk drive 1014, magnetic disk drive 1016 and optical disk drive 1020 can be connected to the system bus 1008 by a hard disk drive interface 1024, a magnetic disk drive interface 1026 and an optical drive interface 1028, respectively. The interface 1024 for external drive implementations includes at least one or both of Universal Serial Bus (USB) and IEEE1394 interface technologies. Other external drive connection technologies are within contemplation of the subject matter claimed herein.

The drives and their associated computer-readable media provide nonvolatile storage of data, data structures, computer-executable instructions, and so forth. For the computer 1002, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, can also be used in the exemplary operating environment, and further, that any such media can contain computer-executable instructions for performing the methods of the claimed subject matter.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. It is appreciated that the claimed subject matter can be implemented with various commercially available operating systems or combinations of operating systems.

A user can enter commands and information into the computer 1002 through one or more wired/wireless input devices, e.g., a keyboard 1038 and a pointing device, such as a mouse 1040. Other input devices (not shown) can include a microphone, an IR remote control, a joystick, a game pad, a stylus pen, touch screen, or the like. These and other input devices are often connected to the processing unit 1004 through an input device interface 1042 that is coupled to the system bus 1008, but can be connected by other interfaces, such as a parallel port, an IEEE1394 serial port, a game port, a USB port, an IR interface, etc.

A monitor 1044 or other type of display device is also connected to the system bus 1008 via an interface, such as a video adapter 1046. In addition to the monitor 1044, a computer typically includes other peripheral output devices (not shown), such as speakers, printers, etc.

The computer 1002 can operate in a networked environment using logical connections via wired and/or wireless communications to one or more remote computers, such as a remote computer(s) 1048. The remote computer(s) 1048 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1050 is illustrated. The logical connections depicted include wired/wireless connectivity to a local area network (LAN) 1052 and/or larger networks, e.g., a wide area network (WAN) 1054. Such LAN and WAN networking environments are commonplace in offices and companies, and facilitate enterprise-wide computer networks, such as intranets, all of which can connect to a global communications network, e.g., the Internet.

When used in a LAN networking environment, the computer 1002 is connected to the local network 1052 through a wired and/or wireless communication network interface or adapter 1056. The adapter 1056 can facilitate wired or wireless communication to the LAN 1052, which can also include a wireless access point disposed thereon for communicating with the wireless adapter 1056.

When used in a WAN networking environment, the computer 1002 can include a modem 1058, can be connected to a communications server on the WAN 1054, or has other means for establishing communications over the WAN 1054, such as by way of the Internet. The modem 1058, which can be internal or external and a wired or wireless device, is connected to the system bus 1008 via the serial port interface 1042. In a networked environment, program modules depicted relative to the computer 1002, or portions thereof, can be stored in the remote memory/storage device 1050. It will be appreciated that the network connections shown are exemplary and other means of establishing a communications link between the computers can be used.

The computer 1002 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least WiFi and Bluetooth™ wireless technologies. Thus, the communication can be a predefined structure as with a conventional network or simply an ad hoc communication between at least two devices.

WiFi, or Wireless Fidelity, allows connection to the Internet from a couch at home, a bed in a hotel room, or a conference room at work, without wires. WiFi is a wireless technology similar to that used in a cell phone that enables such devices, e.g., computers, to send and receive data indoors and out; anywhere within the range of a base station. WiFi networks use radio technologies called IEEE802.11 (a, b, g, n, etc.) to provide secure, reliable, fast wireless connectivity. A WiFi network can be used to connect computers to each other, to the Internet, and to wired networks (which use IEEE802.3 or Ethernet). WiFi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10 BaseT wired Ethernet networks used in many offices.

Referring now to FIG. 11, there is illustrated a schematic block diagram of an exemplary computer compilation system operable to execute the disclosed architecture. The system 1100 includes one or more client(s) 1102. The client(s) 1102 can be hardware and/or software (e.g., threads, processes, computing devices). The client(s) 1102 can house cookie(s) and/or associated contextual information by employing the claimed subject matter, for example.

The system 1100 also includes one or more server(s) 1104. The server(s) 1104 can also be hardware and/or software (e.g., threads, processes, computing devices). The servers 1104 can house threads to perform transformations by employing the claimed subject matter, for example. One possible communication between a client 1102 and a server 1104 can be in the form of a data packet adapted to be transmitted between two or more computer processes. The data packet can include a cookie and/or associated contextual information, for example. The system 1100 includes a communication framework 1106 (e.g., a global communication network such as the Internet) that can be employed to facilitate communications between the client(s) 1102 and the server(s) 1104.

Communications can be facilitated via a wired (including optical fiber) and/or wireless technology. The client(s) 1102 are operatively connected to one or more client data store(s) 1108 that can be employed to store information local to the client(s) 1102 (e.g., cookie(s) and/or associated contextual information). Similarly, the server(s) 1104 are operatively connected to one or more server data store(s) 1110 that can be employed to store information local to the servers 1104.

What has been described above includes examples of the various embodiments. It is, of course, not possible to describe every conceivable combination of components or methodologies for purposes of describing the embodiments, but one of ordinary skill in the art can recognize that many further combinations and permutations are possible. Accordingly, the detailed description is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the embodiments. In this regard, it will also be recognized that the embodiments include a system as well as a computer-readable medium having computer-executable instructions for performing the acts and/or events of the various methods.

In addition, while a particular feature may have been disclosed with respect to only one of several implementations, such feature can be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

What is claimed is:

1. A system for automated electronic coaching, comprising:
a standardization component that establishes a performance benchmark for a task based on a set of performance control standards;
an analysis component that employs a user's interaction with a communication network to characterize user activity pertinent to the task and rate the activity in accomplishing the task relative to the performance benchmark; and
an output component that provides suggestive feedback to the user based on the activity rating and performance control standards.

2. The system of claim 1, further comprising at least one of:
a tracking component that monitors effectiveness of a subset of the user activity based on user interaction with a social network in accomplishing the task; or
an ambient sensor that collects data regarding physical activity or environmental conditions pertinent to the user, the sensor feeds the collected data to the analysis component for characterizing the user activity.

3. The system of claim 2, the tracking component monitors an e-mail, instant message (IM), short message service (SMS), web page, message board or electronic voice interface to the social network to characterize or gauge effectiveness of the user activity.

4. The system of claim 1, further comprising:
a data collection component that aggregates characterized user activities of a set of users pertinent to the task, the aggregated activities form the performance benchmark; and
a ranking component that rates the user with respect to the set of users based on efficiency of the user activity in accomplishing the task compared with a subset of the aggregated activities.

5. The system of claim 1, further comprising a display component that graphically renders the user's interaction or characterized activities relative to a set of benchmark activities for the task.

6. The system of claim 5, the output component employs the graphical rendering to illustrate differences in the user activity and the benchmark activities and demonstrate effectiveness of the suggestive feedback in performance of the task.

7. The system of claim 1, further comprising:
a context component that determines a relationship of the task with an organization goal and defines a set of rules for performing the task consistent with the goal; and
a predictive analysis component that at least one of:
flags content or a recipient of a communication activity pertinent to the task having a risk of violating a subset of the rules; or
outputs an expected or recommended user action consistent with the set of rules.

8. The system of claim 7, wherein:
the organization goal comprises a performance goal, an organizational efficiency goal, a security goal or a legal right; or
the communication activity comprises a direct person-to-person communication or an electronic communication.

9. The system of claim 1, further comprising a benchmark plug-in component that imports as the performance benchmark an importable/exportable external benchmark file having control standards tuned to at least one of:
a second communication network,
a set of network users external to an organization; or
a set of tasks different from the task, or a combination thereof.

10. A method of employing an electronic device to provide automated electronic coaching for a user of the device, comprising:
utilizing a processor of the electronic device to execute the following device-readable instructions:
monitor user interaction with the electronic device or a network interface to characterize user activity pertinent to a task;
rate effectiveness of the user activity in implementing the task with respect to a performance benchmark;
generate suggestive feedback for the user based on the rated activity; and
employ a user interface component of the electronic device to output the suggestive feedback to the user.

11. The method of claim 10, further comprising employing a social networking application of the electronic device for the network interface, the user interaction comprises communication with a set of users of the social network.

12. The method of claim 10, rating the user activity further comprises tracking effectiveness of social network communication in accomplishing the task.

13. The method of claim 10, further comprising utilizing the processor to monitor an e-mail, IM, SMS, web page, message board or electronic voice interface to a network for characterizing the user activity.

14. The method of claim 10, further comprising employing characterized activity of an expert user in accomplishing the task to establish the performance benchmark.

15. The method of claim 10, further comprising analyzing communication content of the interaction in identifying the task or rating the user activity.

16. The method of claim 10, further comprising ranking the user activity in a hierarchy of performance results for the task and providing the ranking as part of the feedback.

17. The method of claim 10, the feedback comprises a multi-dimensional graphical depiction of at least one of:
results of the user activity in implementing the task with respect to the benchmark;
communication pertaining to the task between the user and another person; or
characterized activities of users having a high performance ranking for the task.

18. The method of claim 10, wherein:
the benchmark comprises user protocols pertaining to permissible or suggested task-related user activities based on a goal of the task; and
the feedback comprises at least one of:
emphasis of content of a communication having a determined risk of violating the goal;
identity or alias of persons having relatively high or low likelihood of contributing to achieving the goal; or
one or more of the permissible or suggested task-related user activities having a higher rated effectiveness in accomplishing the goal than the user activity.

19. The method of claim 10, the user interaction comprises an electronic communication received via the electronic device, and further comprising:
analyzing content of the electronic communication to determine an organizational context thereof; and
providing an expected user action in response to the communication that is consistent with the organizational context.

20. A system for automated electronic coaching, comprising:
a benchmark plug-in component that obtains an importable/exportable performance benchmark file tuned to a first social network, organization of network users or set of tasks;
an analysis component that employs user interaction with a second social network to characterize user activity pertinent to a subset of the tasks and rate user performance of the subset of the tasks based on the performance benchmark;
a display component that graphically renders the user interaction or characterized activity, and a set of benchmark interactions for the task; and
an output component that provides feedback configured for modifying the user interaction or a structure of the second network to improve the performance rating, the feedback is output to the display component for user consumption or to a data store for refinement of the characterization of user activity.
